(19) United States
(12) Patent Application Publication
(10) Pub. No.: US 2023/0351533 A1
(43) Pub. Date: Nov. 2, 2023

(54) SYSTEM AND METHODS FOR ASSESSING THE VALUE OF EQUITY IN MULTIPLE PROPERTIES, ESTABLISHING LOAN TERMS, AND FACILITATING THE PROCESS OF A TRADE-IN MORTGAGE

(71) Applicant: Calque, Inc., Austin, TX (US)

(72) Inventor: Jeremy Carl Foster, Austin, TX (US)

(73) Assignee: Calque, Inc., Austin, TX (US)

(21) Appl. No.: 18/296,723

(22) Filed: Apr. 6, 2023

Related U.S. Application Data
(60) Provisional application No. 63/337,081, filed on Apr. 30, 2022.

(51) Int. Cl. G06Q 50/16; G06Q 40/03

(52) U.S. Cl. CPC G06Q 50/167; G06Q 40/03

(57) ABSTRACT

As a function of equity in a homeowner’s current home, a homebuyer is offered a first loan as a function of equity in the homeowner’s current home and approval of a second loan for purchasing a next home. The offering includes a lender of the first loan having to buy the current home from the homeowner at a prescribed price after a prescribed duration of time expires following acceptance of said offering. Origination of the first loan and approval of the second loan is provided in response to the homebuyer accepting the offering. Funding and closing of the second loan is enabled using funds from the first loan in response to an offer on the next home being accepted. The first loan and a mortgage balance amount of the first home are repaid based upon funds obtained by selling the current home after funding and closing of the second loan.

### PRIORITY CLAIMS AND RELATED APPLICATIONS

This application claims the benefit of prior U.S. Provisional Pat. Application Serial No. 63/337,081, filed on Apr. 30, 2022, titled “SYSTEM AND METHODS FOR ASSESSING THE VALUE OF EQUITY IN MULTIPLE PROPERTIES, ESTABLISHING LOAN TERMS, AND FACILITATING THE PROCESS OF A TRADE-IN MORTGAGE,” the entire disclosure of which is hereby incorporated by reference for all purposes as if fully set forth herein.

### TECHNICAL FIELD

The embodiments generally relate to finance and, more particularly, relate to systems, methods and computer-readable medium for modeling, quantifying and/or leveraging of mortgage equity with respect to real estate transactions, where such transaction involve assessing the value of equity in multiple properties, establishing loan terms, and implement (e.g., facilitate) the process of a trade-in mortgage (i.e., a loan).

### BACKGROUND

Mortgage loans are loans used to raise funds to purchase real estate. Alternatively, mortgages may be used by current homeowners (i.e., current property owners) to raise funds for any purpose while placing a lien on a property being mortgaged. Features of the loan, such as size of the loan, maturity, interest rate, method of paying the loan, and other characteristics, can vary considerably.

Current homeowners face various hurdles when attempting to sell a home they currently own (“current home”) while searching for a next home (newly constructed, pre-owned or otherwise). Often, lenders (i.e., banks, finance companies and the like) will not give a current homeowner (i.e., a next home buyer) a new loan for a next home until their current home sells and any previous mortgage on that current home has been paid off. In some cases, a homeowner may first list their current home for sale and wait for that home to sell before searching for a next home. This requires the current homeowner to move out of their current home before securing and being able to move into their next home. This can be quite an inconvenient and costly due to considerations such as, for example, moving logistics and the inability to find a suitable short-term rental. One alternative approach is for a current homeowner to use a third-party to buy a next home. The third-party then leases the next home back to the current homeowner until the homeowner sells their current home and buy the home under lease that they are living in. Although this alternative approach provides a path forward for the current homeowner to eventually buy the next home, it can be expensive.

Some lenders offer bridge loans to allow current homeowners to use the equity in their current home. However, traditional bridge loans have not been widely adopted. One consideration in this regard is that current homeowners have to include the debt from both their current home and a next home in their debt-to-income (DTI) ratio, which more often than not is detrimental to meeting requirements for loan approval due to too high of a DTI. Another such consideration is that lenders are adverse to the risk of the current homeowner being unable to finance mortgages (i.e., make payments on) on both homes (i.e., current and next) for an unknown and possibly extended period of time. Thus, even though the current homeowner may have considerable equity in their current home, it often does not aid them in securing financing for a next home while still owning their current home.

Not surprisingly, traditional processes for buying a next home and selling a current home at the same time creates a huge amount of stress for buyers who need a loan, especially those who already have a mortgage on their current home. For those buyers who already have a mortgage on their current home (i.e., current homeowners), the primary source of this stress is the financing contingency requiring the current homeowner to sell their current home before they can close the loan on their next home. For example, it is well known that Fannie Mae & Freddie Mac purchase a majority of conforming mortgages in the US. These lenders require that all debt payments of a current homeowner, including both the mortgage on their current home and the mortgage for the next home. Debt payments are limited to 36% of a borrower’s income in most cases and up to 45% for highly qualified borrowers. Most current homeowners do not meet these qualification requirements due to the prospective financial burden of having a mortgage on both their current home and the next home. In this case, the current homeowner must become preapproved for a contingent loan.

A requirement of a contingency loan is that the borrower (i.e., current homeowner) cannot close the loan and move into their next home until they sell their current home. This uncertainty also means the seller of next homes typically will value cash offers and more than contingent offers. As such, borrowers, particularly low-income and middle-income borrowers, are often at a disadvantage against cash-buyers looking to purchase a next home in terms of both the likelihood of having their offer accepted and what they’ll pay if that offer is accepted.

In view of the aforementioned lending considerations in regard to concurrently selling a current home and buying a next home, certain companies in the real estate domain have begun implementing measures to facilitate next home purchases for current homeowners seeking to buy a next home while still owning (and often living in) their current home. In some instances, these companies buy the current home on demand in order to enable the current homeowner to qualify for a loan on a next home (i.e., “Instant Buyers” such as, for example OpenDoor). In other instances, these companies buy the new house for the current homeowner and leasing it back to them until their current home sells (i.e., “Bridge Buyers” such as, for example, Knock, Homeward and Orchard).

Companies offering these types of alternative approaches to enabling current homeowners to buy a next home while still owning their current home are now transforming into technology-powered mortgage companies. In doing so, they are circumventing the established homeowner lending environment, often to the detriment of homeowner (i.e., borrower). For example, these types of alternative approaches to enabling current homeowners to buy a next home while still owning their current home are often extremely costly for borrowers, largely because they circumvent the established mortgage ecosystem, which drives both higher financing costs from alternative capital and because they result in duplicate transaction costs from purchasing homes an extra time.

Therefore, systems, methods and computer-readable medium (e.g., non-transitory computer-readable medium) that enable a current homeowner of a current home to buy a next home using equity in the current home while still owning the current home in a manner that overcomes drawbacks associated with conventional lending approaches in this regard would be advantageous, desirable and useful.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Embodiments of the disclosures made herein are directed to systems, methods and computer-readable medium that enable a homeowner of a current home to buy their next home using equity in the current home while still owning the current home (i.e., product in the form of a trade-in mortgage) in a manner that overcomes drawbacks associated with conventional lending approaches. To this end, such systems, methods and computer-readable medium may be configured to assess the value of equity in multiple properties, establish loan terms, and implement the process of a trade-in mortgage. Such systems, methods and computer-readable medium may be configured for providing modeling, quantifying and/or leveraging of mortgage equity with respect to real estate transactions. Such systems, methods and computer-readable medium may establish the amount and loan payment terms of a trade-in mortgage. The trade-in mortgage is a mortgage on a next home in which equity from a current home is used to fund a down-payment for the next home. Such systems, methods and computer-readable medium may comprise, access or otherwise utilize a database to store at least one loan file comprising an appraisal for a second home and a loan estimate corresponding to the second home. To these ends, such systems, methods and computer-readable medium may be configured to perform a first algorithm, executed by a processor, to estimate fund availability from a suitable financial instrument to successfully underwrite a trade-in mortgage on a next home of a borrower and/or to perform a second algorithm, executed by the processor, to determine underwriting eligibility for a loan component of a trade-in mortgage. Such systems, methods and computer-readable medium may be configured to combine algorithms that perform a plurality of loan assessment processes and property underwriting processes (e.g., the two aforementioned algorithms) in support of offering a trade-in mortgage. A home equity loan or line of credit, a bride loan, and an equity advance are examples of suitable forms of financial instruments by which a homeowner may access equity in the current home for funding the loan component of the trade-in mortgage.

Systems, methods and computer-readable medium in accordance with embodiments of the disclosures made herein advantageously provide both a process and significant supporting technology to solve the problem of enabling a current homeowner to buy a next home using equity in their current home while still owning their current home and while not being financially disadvantaged in doing so. This solution involves a lender underwriting the purchase of the current home for the current homeowner at a specified price and in accordance with a specified timeframe while allowing the current homeowner the option of selling their current home to someone until contracting the purchase of the next home (i.e., contingency period). This underwriting of the purchase of the current home, in effect, serves as a contingent bridge loan based at least partially on equity that the current homeowner (i.e., the bridge loan borrower) has in their current home.

During the bridge loan contingency period, the current homeowner may sell their current home to someone thereby alleviating the need for the bridge loan. At the same time, should the current home not sell during the bridge loan contingency period and the current homeowner enters into a contract to buy a next home, the current homeowner may use funding from the bridge loan that is based upon the equity in their current home to make a down-payment on the next home. Preferably, based on loan eligibility information associated with the bridge loan on the current home, the current homeowner receives pre-approval for a mortgage for a next home having a sales price that does not exceed a maximum specified sales price as specified by the bridge loan. This pre-approval is beneficial to the current homeowner as loan pre-approval is desirable to home sellers when selecting a purchase offer to accept. The lender of the contingent bridge loan would then purchase the current home from the current homeowner at the specified price. Advantageously, this process reduces risk and expense for borrowers needing to access equity in their current home, all while remaining fully compliant with all lending requirements and the Fannie Mae & Freddie Mac Sellers’ Guide.

Systems, methods and computer-readable mediums in accordance with embodiments of the disclosures made herein include a process for executing a trade-in mortgage which utilizes structured process workflows, financial algorithms, and technology-driven document containers to facilitate a homeowner’s ability to tap into equity in their current home in order to purchase their next home under conventional or available DTI conditions before selling their current home. Unlike conventional loan estimation methodologies, which focus on determining the individual property being underwritten, systems, methods and computer-readable mediums in accordance with embodiments of the disclosures made herein use information from both the current home (i.e., a first home) and a next home (i.e., a second home) for determining a mortgage on the next home. For example, a down-payment funded by equity in the current home via a loan on the current home is used in underwriting a mortgage for the next home to reduce the effective DTI. Additionally, unlike conventional underwriting methodologies, systems, methods and computer-readable mediums in accordance with embodiments of the disclosures made herein do not calculate current home equity as a separate source of funding contingent upon the sale of the homeowner’s current home.

To reduce risk to the homeowner of the current home and to facilitate utilization of the equity in the current home for down-payment of the next home, the current homeowner of the current home is offered a guaranteed purchase price (PPG) amount for the current home and an associated selling timeframe from closing on the new house after which the current home is guaranteed to be purchased (e.g., a specified no. of days) by a third-party buyer. Examples of the third-party buyer include, but are not limited to, a guaranteed take-out buyer that is a third-party to the entities implementing the trade-in mortgage, the lender for the mortgage on the next home, the lender for the contingent bridge loan, and an entity that implements home trade-in mortgages in accordance with embodiments of the disclosures made herein (which may or may not be the lender for the contingent bridge loan on the current home and/or the lender for the mortgage on the next home). The PPG amount and associated selling timeframe are based on considerations including, but not limited to, housing market conditions for the location of the current home, construction/build/condition information for the current home, equity in the current home, money market information, and the like, where these considerations are preferably managed to reduce risk of the third-party buyer and/or associated entity providing home trade-in mortgages in accordance with embodiments of the disclosures made. Accordingly, and advantageously, the current homeowner of the current home is guaranteed that the current home will be purchased at a guaranteed price and in accordance with a prescribed period of time after closing on the next home, a prescribed period of time after accepting an offer setting forth trade-in mortgage terms and/or the like.

As can be seen, home trade-in mortgages implemented in accordance with the disclosures made herein enable a lender to provide a guaranteed outcome regarding both the risk and the timing of the sale of the homeowner’s current home. These home trade-in mortgages beneficially provide for the offering of an integrated loan (e.g., bridge loan in the form of a HELOC) on the current home and a primary mortgage on a next home by utilizing the equity in the current home to provide the down-payment for the next home via the loan on the current home. As discussed above, equity in the current home is a factor in the underwriting off the contingent bridge loan. When the current home is sold, under the PPG, the loan on the current home is repaid and the homeowner is left with a conventional mortgage (i.e., loan) on the next home. This approach to financing the next home using a loan underwritten as a function of equity of the current home allows the homeowner to avoid costly third-party purchasers and to transition directly from the current home to the next home without the need to find a short-term residence.

In one or more embodiments, a method of implementing a trade-in mortgage in accordance with the disclosures made herein comprising a plurality of processor-implemented algorithmic operations. A loan accessing equity in a homeowner’s current home (i.e., a first home loan which may be a HELOC or other suitable form of financial instrument by which a homeowner may access equity in the homeowner’s current home) is originated (i.e., a consumer and borrower in a loan process). For enabling the homeowner to buy a next home (i.e., a second home that will be a new home of the homeowner) while the homeowner’s current home is still for sale, a mortgage is preapproved for the homeowner to buy the second home using proceeds from the first home loan to fund the downpayment for the second home mortgage. There may or may not be an existing mortgage on the first home and, even in the case where there is not an existing mortgage on the first home, the first home loan may have a second lien attached thereto. Once an offer of the second home by the homeowner is accepted, origination of the second home is then initiated, followed by the funding and closing of the second home sale being executed. In conjunction with the funding and closing of the second home sale being executed, the first home loan is extended, as needed to provide required funds to the homeowner (e.g., for moving expenses, move-in expenses, etc.). During the trade-in mortgage process, the first home is sold either conventionally by the seller to a third party or, otherwise, to the entity through which the trade-in mortgage is being offered (i.e., the trade-in mortgage lender, affiliate thereof, or the like.) Funds from sale of the second home are used to replay the first home loan and, if applicable, any outstanding fees, costs interest and the like associated with the completing the trade-in mortgage process.

In one or more embodiments, a non-transitory computer-readable medium carrying one or more sequences of instructions is configured for implementing a loan offering enabling equity in a current home of a homeowner to be used in securing a loan for use in purchasing a next home of the homeowner. Execution of the one or more sequences of instructions by one or more processors causes the one or more processors to perform a plurality of processor-implemented algorithmic operations. As a function of equity in a current home of a homeowner, an operation is performed for offering the homebuyer a first loan and, in conjunction with the first loan being originated, approval of a second loan for purchasing a next home. The offering includes requirement of a lender of the first loan to buy the current home from the homeowner at a prescribed price in response to expiration of a prescribed duration of time following at least one of acceptance of said offering and an offer by the homeowner of the next home being accepted. An operation is performed for originating the first loan and approving the second loan in response to the homebuyer accepting the offering. An operation is performed for enabling funding and closing of the second loan using funds from the first loan in response to an offer on the next home by the homeowner being accepted. An operation is performed for repaying the first loan and a mortgage balance amount of the first home based upon funds obtained by selling the current home after funding and closing of the second loan.

In one or more embodiments, a loan origination system having a non-transitory computer-readable medium carrying one or more sequences of instructions is configured for implementation of a loan offering enabling equity in a current home of a homeowner to be used in securing a loan for use in purchasing a next home of the homeowner. Execution of the one or more sequences of instructions by one or more processors causes the one or more processors to perform a plurality of processor-implemented algorithmic operations. As a function of equity in a current home of a homeowner, an operation is performed for offering the homebuyer a first loan and, in conjunction with the first loan being originated, approval of a second loan for purchasing a next home. The offering includes requirement of a lender of the first loan to buy the current home from the homeowner a prescribed price in response to expiration of a prescribed duration of time following at least one of acceptance of said offering and an offer by the homeowner of the next home being accepted. An operation is performed for originating the first loan and approving the second loan in response to the homebuyer accepting the offering. An operation is performed for enabling funding and closing of the second loan using funds from the first loan in response to an offer on the next home being accepted. An operation is performed for repaying the first loan and a mortgage balance amount of the first home based upon funds obtained by selling the current home after funding and closing of the second loan.

In one or more embodiments, a method enables equity in a current home of a homeowner to be used in securing a loan for use in purchasing a next home of the homeowner. The method comprising a plurality of processor-implemented algorithmic operations. One operation includes originating, by a non-transitory computer-readable medium of a loan origination system, a first loan based at least partially based on an amount of equity in a current home of a homeowner in response to the homeowner accepting a loan offer. The loan offer includes requirement of a lender of the first loan to buy the current home from the homeowner a prescribed price in response to expiration of a prescribed duration of time following at least one of acceptance of said offering and an offer by the homeowner of the next home being accepted. Another operation includes preapproving, by the non-transitory computer-readable medium of the loan origination system, a second loan for purchasing a next home of the homeowner in response to origination of first loan. Another operation includes initiating, by the non-transitory medium computer-readable of the loan origination system, origination the second loan in response to notification that an offer on the next home has been accepted. Another operation includes causing, by the non-transitory medium computer-readable of the loan origination system, proceeds provided from the first loan to be used for funding and closing sale of the next home. Another operation includes causing, by the non-transitory medium computer-readable of the loan origination system, the first loan and a mortgage balance amount of the first home to be paid off using proceeds from sale of the current home in response to receiving information confirming the current home as being sold.

In one or more embodiments, a non-transitory computer-readable medium carrying one or more sequences of instructions is configured for implementing a loan offering enabling equity in a current home of a homeowner to be used in securing a loan for use in purchasing a next home of the homeowner. Execution of the one or more sequences of instructions by one or more processors causes the one or more processors to perform a plurality of processor-implemented algorithmic operations. As a function of equity in a current home of a homeowner, an operation is performed for deriving terms for a loan offering required for the homeowner to purchase the next home. The loan offering includes origination of a first loan and approval of a second loan. The deriving is performed in accordance with a requirement of a lender of the first loan to buy the current home from the homeowner at a prescribed price in response to expiration of a prescribed duration of time following at least one of acceptance of said offering and an offer by the homeowner of the next home being accepted. An operation is performed for receiving information generated during origination of the first loan and approval of the second loan in response to the homebuyer accepting in the loan offering. An operation is performed for enabling funding and closing of the second loan using funds from the first loan in response to an offer on the next home by the homeowner being accepted. An operation is performed for causing the first loan and a mortgage balance amount of the first home to be repaid based upon funds obtained by selling the current home after funding and closing of the second loan.

These and other objects, embodiments, advantages and/or distinctions of the present invention will become readily apparent upon further review of the following specification, associated drawings and appended claims.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 is a flowchart showing a framework for implementing a trade-in mortgage offering, according to some embodiments;

FIG. 2 is a flowchart showing a method for implementing a trade-in mortgage offering that includes the combining of two property underwriting processes, according to some embodiments;

FIG. 3 is a flowchart showing implementation of an algorithmic process for implementing a trade-in mortgage offering, according to some embodiments;

FIG. 4 is a flowchart showing implementation of operations for generating certain purchase price guarantee terms, according to some embodiments; and

FIG. 5 is a block diagram of a network infrastructure including a computing system adapted for implementing a trade-in mortgage offering, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the disclosed systems, methods and computer-readable mediums. Accordingly, the system, method and computer-readable medium components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosures described herein relate to a process for executing a trade-in mortgage which utilizes structured process workflows, financial algorithms, and technology-driven document containers to facilitate a homeowner’s ability to tap into equity in their existing (i.e., current) home in order to for the homeowner to purchase their next home before selling their current home. Although loan estimation methodologies exist in the mortgage space, they have been primarily determined based on the individual properties being underwritten rather than as a combination of the homeowner’s current and next homes (i.e., properties). Conventional underwriting methodologies sometimes consider equity in the current home as a potential funding source, but it is calculated as a separate source of funding contingent upon the sale of the homeowner’s current home, rather than as part of a combined valuation and underwriting process.

In addition to the estimation methodology differences, trade-in mortgages (i.e., loans) in accordance with the disclosures made herein differ from a home equity loan, a home equity line of credit (HELOC) and a bridge loan in the traditional sense in that a trade-in mortgage process in accordance with the disclosures made herein is initiated with a guaranteed take-out buyer for the homeowner’s current home. This provides the lender with a guaranteed outcome regarding both the risk and the timing of the sale of the homeowner’s current home. In conjunction with technology-managed workflows, a trade-in mortgage in accordance with the disclosures made herein translates to the ability to provide an integrated home equity loan on a homeowner’s current home and a primary mortgage on the homeowner’s next home, where equity in the current home is utilized to provide the down-payment for the next home. When the current home is sold, the home equity loan on the current home is repaid along with the existing home mortgage balance and the homeowner is left with a conventional mortgage on the next home.

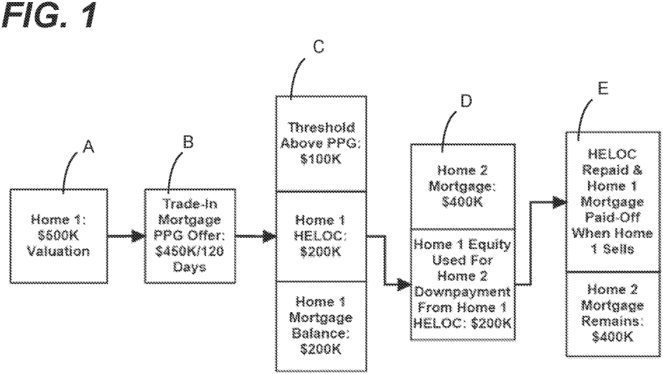

Referring to FIG. 1, a framework for offering a trade-in mortgage is shown. A current home (i.e., Home 1) has a given valuation (e.g., $500K), as shown at Block A. A purchase price guarantee (PPG) Offer for the current home (e.g., $450K purchase price with a 120-day purchase timeframe for the existing home) is generated, as shown in block B. The PPG Offer is generated as a function of information specific to the current home - e.g., home market data (e.g., valuation of the existing home and homes within a designated region around the current home), current home equity, home build/condition information, formulaic algorithms deriving data from prescribed information, and the like. The PPG Offer specifies a time period over which the PPG Offer extends (i.e., a PPG Offer Pendency Period) and specifies a purchase price for which the current home is guaranteed to be purchased by the trade-in mortgage lender if the home does not otherwise sell prior to expiration of the PPG Offer pendency period (i.e., the PPG Amount). Loan underwriting information for a trade-in mortgage is generated using current home information and the PPG (e.g., $200K Current home Balance, $200K Current home Equity-Based Loan (e.g., a HELOC or other suitable form of financial instrument by which a homeowner may access equity in the current home), and $100K threshold above the PPG Offer amount for the existing home), as shown in Block C. Loan underwriting information is generated for the next home based upon the information garnished from the loan underwriting information and from purchase information for the loan on the next home (e.g., current home equity used for next home down payment, mortgage balance on current home, etc.), as shown in Block D. The trade-in mortgage on the current home and the mortgage balance on the current home are paid off when current home sells, leaving the homeowner with only a mortgage on the next home, as shown in Block E. This process is beneficial to the homeowner in that it allows them to utilize equity in purchasing a next home prior to selling their current home in a manner that precludes compromising their DTI ratio and that allows them to buy more home and/or reduce the incurred about of debt associated with their next home.

Beneficially, the homeowner may sell the current home at any point in time prior to expiration of the PPG Offer Pendency Period. Generally, the homeowner would choose to sell the current home to a third-party during the PPG Offer Pendency Period in the case where the current home sells at a price that is greater than the PPG plus the lender’s fee and any incidental amount(s) that would be incurred via purchase of the current home by the trade-in mortgage lender. In the case where the current home is sold to a third party prior to an offer being accepted on a next home (i.e., pursuant to terms of the PPG Offer), the PPG Offer terminates (e.g., via a termination clause of the PPG Offering) and the homebuyer owes the trade-in mortgage lender the lender’s fee.

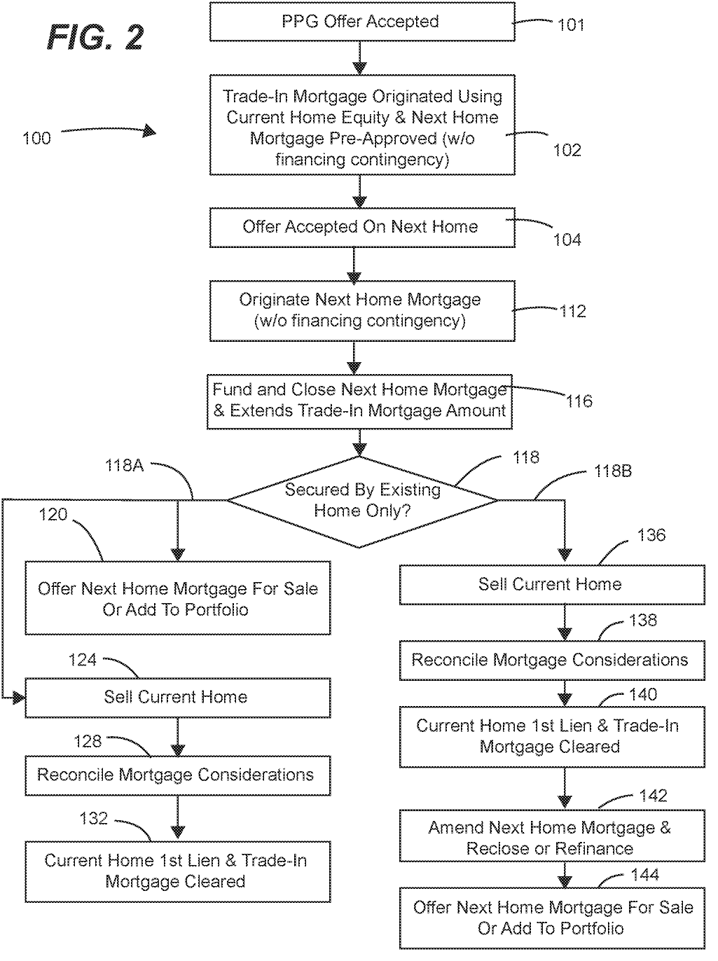

FIG. 2 shows a method 100 for implementing a trade-in mortgage offering (i.e., a PPG offer) in accordance with the disclosures made herein. Advantageously, this process includes the combining of two property underwriting process workflows for combining two properties associated with a homeowner (i.e., a homeowner’s current home and a next home that the homebuyer intends to purchase) to facilitate a trade-in mortgage. To this end, in operation 101, the homeowner accepts a PPG Offer made by a trade-in mortgage lender on the homeowner’s current home (i.e., a first home). Upon acceptance of the PPG Offer, the homeowner commits to paying the trade-in mortgage lender a lender’s fee (i.e., PPG Offering Fee), which is required to be paid by the homeowner to the trade-in mortgage lender regardless of the party that buys the current home. In operation 102, a trade-in mortgage secured by equity in the current home is originated on the current home is and the homeowner receives preapproval for a loan (i.e., a mortgage) for a next home (i.e., a second home), which may or may not yet be known to the homeowner). A home equity loan or line of credit, a bride loan, and an equity advance are examples of suitable forms of financial instruments by which a homeowner may access equity in the current home. In preferred embodiments, origination of the trade-in mortgage includes ordering title of the current home and determining the current value of the current home utilizing licensed Automated Valuation Model (AVM) data, where the AVM model may be integrated into the system that facilitated implementation of the trade-in mortgage process. The current value of the current home may also be determined using on-site evaluation or full appraisal (policy established by market). Once the trade-in mortgage is secured, the homeowner may use proceeds from the trade-in mortgage to make a contingency-free offer and associated down-payment on the next home.

After (e.g., in response to) the offer on the next home by the homeowner is accepted in operation 104, a loan for the next home (i.e., next home mortgage) is initiated and originated via a next home mortgage lender in operation 112. Beneficially, in view of securing the trade-in mortgage, the loan for the next home may be secured in a non-contingency based manner which is highly desirable to a seller of the next home as it reduces, if not eliminates, unknows associated with the buyer qualifying for the next home mortgage and associated closing on the next home. In operation 116, after an origination process (i.e., standard or otherwise) for the next home is completed, funding via the trade-in mortgage is received for allowing the homeowner to close the selling process on the next home in conjunction with the trade-in mortgage being extended to allow the homeowner to make payment(s) on the next home and to pay incidental costs/fees associated with associated with buying the next home and/or selling the current home.

In operation 118, a determination is made as to whether the trade-in mortgage was secured by only the current home (118A) or by both the current home and the next home (118B). When the trade-in mortgage is secured by just the existing house, the mortgage (i.e., a loan) on the next home can either by sold or put in portfolio as soon as the mortgage on the next home is closed, regardless of whether the first home has sold. In contrast, when the trade-in mortgage is secured by collateral on both the existing and next homes, the mortgage on the next home cannot be sold until the current home sells.

Thus, in the case where it is determined that the trade-in mortgage is secured by only the current home (118A), the next home mortgage is offered for sale or added to a lender (e.g., the next home mortgage lender) portfolio in operation 120 and, in accordance with the terms of the PPG Offer Pendency Period, the current home is sold (i.e., purchase is funded and closed) in operation 124 - e.g., via the homeowner to a third party at an agreed upon price above the purchase price specified in the PPG Offer if the current home is sold within the PPG Offer Pendency Period and to the trade-in mortgage lender at the purchase price specified in the PPG offer if the PPG Offer Pendency Period has expired. Next, trade-in mortgage considerations (e.g., closing costs, interest owed, PPG Offering Fee, etc.) are reconciled in operation 128, followed by necessary commitments (e.g., the 1^{st} lien) on the current home being cleared (i.e., first mortgage on the current home being paid off) and the trade-in mortgage being cleared (i.e., paid off) in operation 132.

Otherwise, in the case where it is determined in operation 118B that the trade-in mortgage is secured by both the current home and the next home, the current home must be sold prior to final disposition of the next home mortgage to satisfy well-known lending requirements in this regard. To this end, in accordance with the terms of the PPG Offer Pendency Period, the current home is sold in operation 136. Next, trade-in mortgage considerations (e.g., closing costs, interest owed, PPG Offering Fee, etc.) are reconciled in operation 138, followed by required commitments on the current home being cleared and the trade-in mortgage being cleared (i.e., paid off) in operation 140. Then, in operation 142, the next home mortgage is amended and reclosed or is refinanced as required. Thereafter, the next home mortgage is offered for sale or added to a lender portfolio in operation 144.

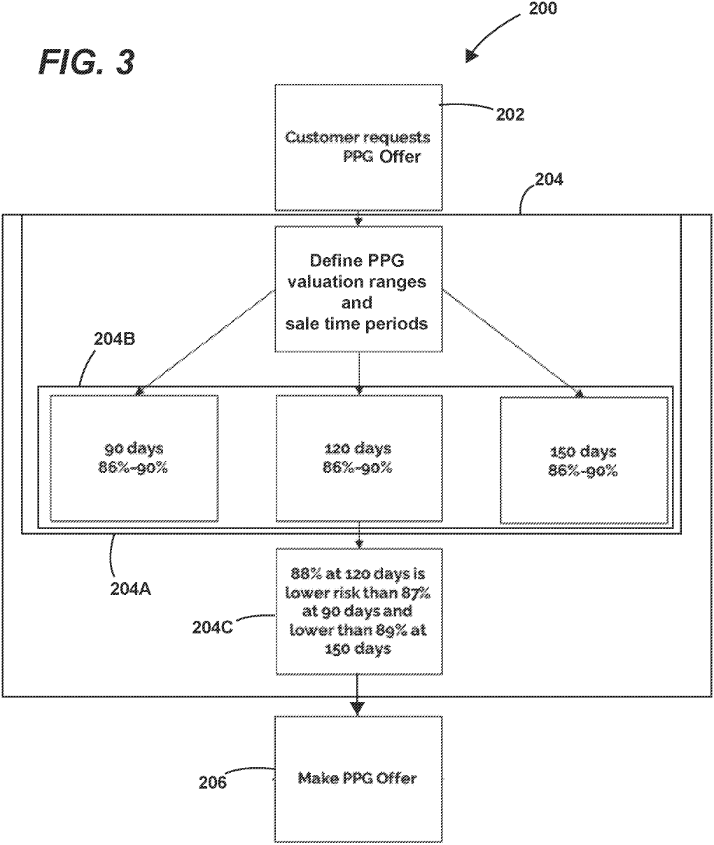

FIG. 3 shows implementation of a process 200 for implementing a trade-in mortgage offering in accordance with some embodiments of the disclosures made herein. Such a process for implementing a trade-in mortgage offering includes a homeowner (i.e., customer) request for a PPG Offering (PPG Offering Request) for their current home being received by a Trade-in Mortgage lender (block 202). In response to receiving the PPG Offering Request, a process (block 204) is performed for generating the PPG Offering (i.e., Offering Generation Process). As previously disclosed, the PPG Offer is generated as a function of information specific to the current home and specifies both the PPG Offer Pendency Period and a corresponding PPG Amount (e.g., a range thereof). In a PPG Terms Generation portion (block 204A) of the Offering Generation Process 204, a plurality of pairings of PPG Offer Pendency Period and PPG Amount (PPG Pairings 204′) are formulaically generated based upon available information relating to the current home, its, location, condition, and the like. These PPG pairings 204′ represent quantification of risk to the trade-in mortgage lender as related to having to purchase the homeowner’s current home for a specified amount after a particular PPG Offer Pendency Period has expired.

A most preferred one of the PPG pairings 204C is selected (e.g., based on algorithmic determination for a given zip code) as a basis for the PPG Offering. For example, the selected PPG pairing 204C may be determined in view of being the least risky pairing among all of the pairings when, for example, considering the PPG Offer Pendency Period as an algorithmic function of the PPG Amount, considering the PPG Amount as an algorithmic function of the PPG Offer Pendency Period, considering PPG Offer Pendency Period as the primary selection factor, considering PPG Amount as the primary selection factor, or the like. After the selected PPG pairing 204C is determined, the PPG Offering is presented to the homeowner for consideration of acceptance, which results in implementing of a trade-in mortgage offering process if the homeowner timely accepts the PPG Offering (e.g., in operation 206 of the trade-in mortgage offering process of FIG. 2).

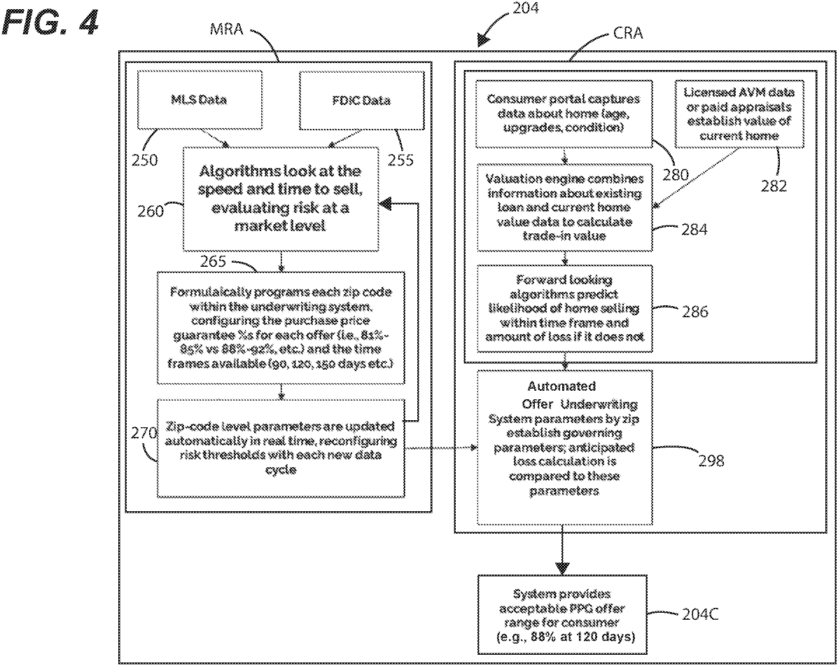

Turning now to FIG. 4, an embodiment of the Offering Generation Process discussed above in reference to FIG. 3 is shown. Advantageously, embodiments of the Offering Generation Process enable a trade-in mortgage lender to deliver associated services efficiently while minimizing certain risks to itself and minimizing certain risks to the consumer (i.e., homeowner). In more detail than that shown in FIG. 3, the depicted embodiment of the Offering Generation Process 204 in FIG. 4 includes assessing both a forward-looking projection of risk associated with offering trade-in mortgages in a particular housing market (Market-Based Risk Assessment - “MRA”) and a forward-looking projection of risk associated with offering trade-in mortgages in a particular housing market for a particular home that would serve as collateral (Collateral-Based Risk Assessment - “CRA”). The MRA and the CRA may be integrated components of a system that provides for automated underwriting of trade-in mortgages (Automated Offer Underwriting System (AOUS), which is an example of a trade-in mortgage origination system in accordance with embodiments of the disclosures made herein).

In regard to the MRA, home value trends and time to sell by zip code are evaluated to both select which markets a trade-in lender may beneficially choose to operate in and to also establish the parameters for PPGs in each zip code (i.e., maximum % of appraised value offered and maximum amount of existing home selling time for each PPG). To this end, in some embodiments, the MRA may utilize two external data sets - Multiple Listing Service (MLS) data 250 and Federal Deposit Insurance Corporation (FDIC) data 255. Both the MLS data 250 and the FDIC data 255 track information that may include all or some of, for example, home sizes and valuation, valuation and/or sales prices per square foot, time on market, changes in valuation and projection of home values on a forward-looking basis and the like (i.e., Home Information). The MRA applies algorithmic assessment 260 to factors that are derived/obtained from the MLS data 250 and FDIC data 255. Examples of such factors include, but are not limited to, changes in mortgage interest rates, difference in value per SF for different property sizes and the like. Zip code-level PPG Offer Pendency Periods and associated PPG Amounts are provided such as by algorithmic assessment 265 via formulaic programs for sample properties (i.e., homes) derived from the Home Information, which represent Zip Code-Level PPG Risk Information. This information characterizes risk thresholds on a zip code-level basis for requested PPG Offers. An objective of the algorithmic assessment 265 is to use available data on homes within a zip code to determine risk of selling homes located within the zip code as a function of factors that may include one or more of various portions of Home information, sales price of homes in the zip code, days on the market of homes in the zip code, equity in the first home, balance due on a mortgage on the first home and the like. Further algorithmic assessment 270 provides for automatic updating of the Zip Code-Level PPG Risk Information (e.g., in a real-time manner) to periodically reconfigure PPG Offer risk thresholds on zip code-level basis. For facilitating generation of PPG Offers, the Zip Code-Level PPG Risk Information is provided to the Automated Offer Underwriting System (AOUS) 298.

Concurrent with or independent of the MRA, the CRA receives information from a homeowner characterizing certain aspects of their current home for which they would like to obtain a PPG Offer (i.e., Homeowner-Provided Request Information 280). Preferably, the homeowner delivers the Homeowner-Provided Request Information 280 via a digital means such as, for example, an on-line portal. Examples of the Homeowner-Provided Request Information 280 includes, but is not limited to, factors related to the condition of the home, factors related to build and layout configuration of the home, factors related to property upon which the home is built, factors related to a location of the home, factors related to equity in the home, and the like. In conjunction with or in response to the CRA receiving the Homeowner-Provided Request Information 280, one or more licensed AVM data (AVM Data) 282 may be accessed to enable utilization of valuation information thereof(e.g., AOUS-integrated AVM).

Using the Homeowner-Provided Request Information 280 and AVM Data 282, algorithmic assessment 284 utilizes including current home mortgage (i.e., loan) information and value information (e.g., market value and associated home equity) to compute a trade-in mortgage amount (i.e., the PPG Amount for the homeowner’s current home). In combination with or in response to computation of the trade-in mortgage value, algorithmic assessment 286 computes the likelihood of the homeowner’s current home selling at the PPG Amount prior to expiration of the PPG Offer Pendency Period and an associated loss association with purchase of the current home. For facilitating generation of PPG Offers (i.e., similarly to the Zip Code-Level PPG Risk Information), the PPG Offer Pendency Period and the PPG Amount for the current home are than provided to the Automated Offer Underwriting System (AOUS) 298 for enabling a PPG Offer including the PPG Offer Pendency Period and PPG Amount to be provided to the homeowner of the existing home for acceptance consideration (e.g., as depicted at block 206 in FIG. 3).

In some embodiments, computing the PPG Offer Pendency Period and the PPG Amount may include automatically applying algorithms (e.g., embedded within the AOUS) which utilize all or a portion of Homeowner-Provided Request Information and Zip Code-Level PPG Risk Information in computing (i.e., determining) a distribution curve around the likelihood that the trade-in mortgage lender will have to purchase the current home, where this distribution curve is then applied to appraised and projected value of the current home to calculate the underlying financial risk to the trade-in mortgage lender. For example, the trade-in mortgage lender may access this risk value for a plurality of possible PPG Offers across a plurality of computed PPG Amount ranges and a plurality of computed PPG Offer Pendency Periods and then choose a to-be-offered PPG Offering based at least partially upon the homeowner’s actual objectives and the trade-in mortgage lender’s established risk parameters for the zip code (i.e., geographic region) in which the current home is located.

In some embodiments, methods (and processes thereof) for facilitating a trade-in mortgage in accordance with embodiments of the disclosures made herein may include an algorithm (referred to herein as Algorithm 1) for estimating the HELOC fund availability required to successfully underwrite the trade-in mortgage. This algorithm may, for example be integral with the AOUS The algorithm and may be configured as follows: Algorithm 1 = (A*(1-B)+A*C+D*E+F-G)+(H*I)*(A*(1-B)+A*C+D*E+F-G), wherein: A = Purchase price of home to be purchased (the second home); B = Initial loan to value (LTV) percentage of the second home; C = Estimated percentage of buyer’s portion of closing costs on the second home; D = Estimated value of the current home (the first home); E = Estimated seller’s closing cost on the first home; F = Estimated interest accrued on the first mortgage on the first home between funding of the mortgage on the next home and maximum closing period allowed on the sale of the first home prior to the guaranteed sale price; G = Cash available for purchase; H = Maximum funding period allowed for trade-in mortgage before guaranteed sale of the first home is exercised (in days); and I = Anticipated daily interest rate on HELOC (in APR with compounding interest).

In some embodiments, methods (and processes thereof) for facilitating a trade-in mortgage in accordance with embodiments of the disclosures made herein may include an algorithm (referred to herein as Algorithm 2) for determining underwriting eligibility for the HELOC component of a trade-in mortgage (e.g., a trade-in mortgage). This algorithm may, for example be integral with the AOUS The algorithm and may be configured as follows: Algorithm 2 = if J*D-[(A*(1-B)+A*C+D*E+F-G)+(H*I)*(A*(1-B)+A*C+D*E+F-G)]-K >0, conditionally approve and proceed; wherein: A = Purchase price of home to be purchased (the second home); B = Initial loan to value (LTV) percentage of the home to be purchased (the second home); C = Estimated percentage of the buyer’s portion of closing costs on the second home; D = Estimated value of the first home; E = Estimated sellers closing cost on the first home; F = Estimated interest accrued on the first mortgage on the first home between funding of the mortgage on the next home and maximum closing period allowed on the sale of the first home prior to the guaranteed sale price; G = Cash available for the purchase of the second home; H = Maximum funding period allowed for trade-in mortgage before guaranteed sale of the first home is exercised (in days); I = Anticipated daily interest rate on HELOC (in APR with compounding interest); J = Combined loan-to-value (CLTV) HELOC allowed under applicable regulatory requirements; and K = Outstanding loan balance of all loans to which the HELOC will be subordinate.

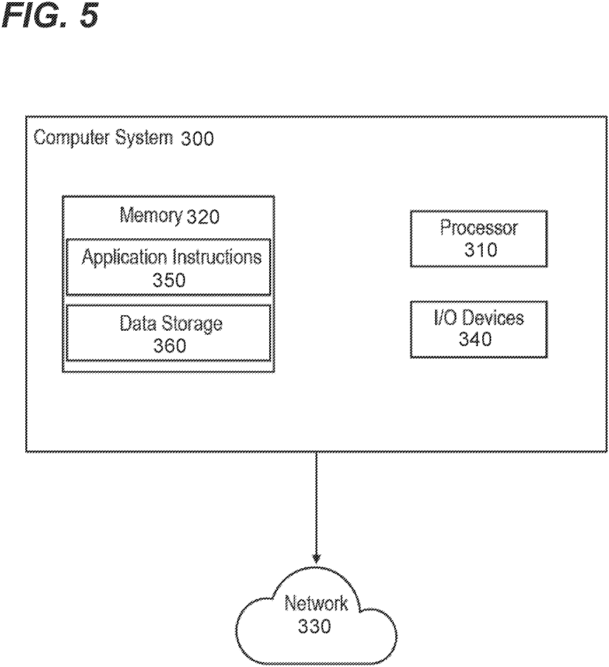

Systems, method and computer-readable medium for providing home trade-in mortgages in accordance with the disclosures made herein may be implemented by a computer system (i.e., computer-implemented methodologies) to automate the various processor-implemented algorithmic operations (e.g., steps) of the process. FIG. 5 illustrates an exemplary network infrastructure of the system. A computer system 300 may be utilized to execute the processes described herein (e.g., the trade-in mortgage process of FIG. 2). The computer system 300 is comprised of a standalone computer or mobile computing device, a mainframe computer system, a workstation, a network computer, a desktop computer, a laptop, or the like. The computer system 300 includes one or more processors (processor(s) 310) coupled to a memory 320 via an input/output (I/O) interface. Computer system 300 may further include a network interface to communicate with the network 330. One or more input/output (I/O) devices 340, such as video device(s) (e.g., a camera), audio device(s), and display(s) are in operable communication with the computer system 300. In some embodiments, similar I/O devices 340 may be separate from computer system 300 and may interact with one or more nodes of the computer system 300 through a wired or wireless connection, such as over a network interface.

Processor(s) 310 suitable for the execution of a computer program include both general and special purpose microprocessors and any one or more processors of any digital computing device. Processor(s) 310 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 300 and other devices attached to a network 330, such as other computer systems, or between nodes of the computer system 300. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

Memory 320 may include application instructions 350, configured to implement certain aspects of embodiments described herein (e.g., a trade-in mortgage process or certain aspects thereof), and a database 360, comprising various data accessible by the application instructions 350. In one embodiment, the application instructions 350 may include software elements corresponding to one or more of the various embodiments described herein. For example, application instructions 350 may be implemented in various embodiments using any desired programming language, scripting language, or combination of programming languages and/or scripting languages (e.g., C, C++, C#, JAVA®, JAVASCRIPT®, PERL®, etc.).

Memory 320 may store loan information, appraisal amounts for the first home or the second home, loan estimates, and similar information related to the processes of buying and selling a home. Memory 320 will also store the first and second algorithms described hereinabove to provide a means for establishing the amount and loan payment terms of a trade-in mortgage.

The operations and actions of the computer system 300 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to processor(s) 310 such that processor(s) 310 can read information from, and write information to, the storage medium. In the alternative, the storage medium may be integrated into processor(s) 310. Further, in some embodiments, processor(s) 310 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine- readable medium or computer-readable medium, which may be incorporated into a computer program product.

Also, any connection may be associated with a computer-readable medium and, more preferably, a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

The term “computer-readable medium” as used herein refers to any medium (but, preferably non-transitory) that participates in providing instructions to processor(s) 310 for execution. Such a medium may take many forms, including but not limited to, non-volatile media, volatile media, and transmission media. Non-volatile media includes, for example, optical or magnetic disks. Volatile media includes dynamic memory, such as memory 320. Transmission media includes coaxial cables, copper wire, and fiber optics, including the wires that comprise a bus. Transmission media can also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read. Various forms of computer readable media may be involved in carrying one or more sequences of one or more instructions to processor(s) 310 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on a bus. A bus in this regard may carry data to memory (e.g., memory 320), from which a processor (e.g., the one or more processors 310) retrieves and executes the instructions. The instructions received by memory may optionally be stored on a storage device either before or after execution by a processor. To this end, the one or more processors 310, the memory 320 and I/O devices 340 are preferably interconnected with each other via a bus or similar communication structure.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

Many different embodiments have been disclosed herein, in connection with the above description and the drawings. It will be understood that it would be unduly repetitious and obfuscating to describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a sub-combination or variation of a sub-combination.

It will be appreciated by persons skilled in the art that the present embodiment is not limited to what has been particularly shown and described hereinabove. A variety of modifications and variations are possible in light of the above teachings without departing from the following claims.

What is claimed is:

1. A non-transitory computer-readable medium carrying at least one set of instructions configured for implementing a loan offering enabling equity in a current home of a homeowner to be used in securing a loan for use in purchasing a next home of the homeowner, where execution of the at least one set of instructions by at least one processor causes the at least one processor to perform at least the processor-implemented algorithmic operations of:
as a function of equity in a current home of a homeowner, deriving terms for a loan offering required for the homeowner to purchase the next home, wherein the loan offering includes origination of a first loan and approval of a second loan and wherein said deriving is performed in accordance with a requirement of a lender of the first loan to buy the current home from the homeowner at a prescribed price in response to expiration of a prescribed duration of time following at least one of acceptance of said offering and an offer by the homeowner of the next home being accepted;
receiving information generated during origination of the first loan and approval of the second loan in response to the homebuyer accepting in the loan offering;
enabling funding and closing of the second loan using funds from the first loan in response to an offer on the next home by the homeowner being accepted; and
causing the first loan and a mortgage balance amount of the first home to be repaid based upon funds obtained by selling the current home after funding and closing of the second loan.

2. The non-transitory computer-readable medium of claim 1 wherein execution of the at least one set of instructions by the at least one processor causes the at least one processor to further perform the processor-implemented algorithmic operation of:
for a zip code within which the current home is located, using available data on other homes within the zip code to determine the prescribed price and the prescribed duration of time.

3. The non-transitory computer-readable medium of claim 2 wherein using available data on other homes within the zip code to determine the prescribed price and the prescribed duration of time includes determining risk of selling homes located within the zip code as a function of sales price and days on the market.

4. The non-transitory computer-readable medium of claim 2 wherein using available data on other homes within the zip code to determine the prescribed price and the prescribed duration of time includes assessing a purchase price of the first home as a function of equity in the first home and a mortgage balance of the first home.

5. The non-transitory computer-readable medium of claim 4 wherein using available data on other homes within the zip code to determine the prescribed price and the prescribed duration of time includes determining risk of selling homes located within the zip code as a function of sales price and days on the market.

6. The non-transitory computer-readable medium of claim 1 wherein execution of the at least one set of instructions by the at least one processor causes the at least one processor to further perform the processor-implemented algorithmic operation of:
in conjunction with the offer on the next home by the homeowner being accepted, causing funding of a down payment on the second home to be made using proceeds from the first loan prior to the first home being sold.

7. The non-transitory computer-readable medium of claim 1 wherein repaying the first loan and the mortgage balance amount is performed after said funding and closing of the second loan.

8. The non-transitory computer-readable medium of claim 7 wherein execution of the at least one set of instructions by the at least one processor causes the at least one processor to further perform the processor-implemented algorithmic operation of:
in conjunction with the offer on the next home by the homeowner being accepted, causing funding of a down payment on the second home to be made using proceeds from the first loan prior to the first home being sold.

9. The non-transitory computer-readable medium of claim 8 wherein said origination of the first loan and said approval of the second loan are performed prior to the first home being sold.

10. The non-transitory computer-readable medium of claim 9 wherein repaying the first loan and the mortgage balance amount is performed after said funding and closing of the second loan.

11. The non-transitory computer-readable medium of claim 10 wherein execution of the at least one set of instructions by the at least one processor causes the at least one processor to further perform the processor-implemented algorithmic operation of:
for a zip code within which the current home is located, using available data on other homes within the zip code to determine the prescribed price and the prescribed duration of time.

12. The non-transitory computer-readable medium of claim 11 wherein using available data on other homes within the zip code to determine the prescribed price and the prescribed duration of time includes determining risk of selling homes located within the zip code as a function of sales price and days on the market.

13. The non-transitory computer-readable medium of claim 11 wherein using available data on other homes within the zip code to determine the prescribed price and the prescribed duration of time includes assessing a purchase price of the first home as a function of equity in the first home and a mortgage balance of the first home.

14. The non-transitory computer-readable medium of claim 4 wherein using available data on other homes within the zip code to determine the prescribed price and the prescribed duration of time includes determining risk of selling homes located within the zip code as a function of sales price and days on the market.

15. A loan origination system having a non-transitory computer-readable medium carrying at least one set of instructions configured for implementation of a loan offering enabling equity in a current home of a homeowner to be used in securing a loan for use in purchasing a next home of the homeowner, where execution of the at least one set of instructions by at least one processor causes the one or more processor to perform at least the processor-implemented algorithmic operations of:
as a function of equity in a current home of a homeowner, deriving terms for a loan offering required for the homeowner to purchase the next home, wherein the loan offering includes origination of a first loan and approval of a second loan and wherein said deriving is performed in accordance with a requirement of a lender of the first loan to buy the current home from the homeowner at a prescribed price in response to expiration of a prescribed duration of time following at least one of acceptance of said offering and an offer by the homeowner of the next home being accepted;
receiving information generated during origination of the first loan and approval of the second loan in response to the homebuyer accepting in the loan offering;
enabling funding and closing of the second loan using funds from the first loan in response to an offer on the next home by the homeowner being accepted; and
causing the first loan and a mortgage balance amount of the first home to be repaid based upon funds obtained by selling the current home after funding and closing of the second loan.

16. The loan origination system of claim 15 wherein execution of the at least one set of instructions by the at least one processor causes the at least one processor to further perform the processor-implemented algorithmic operation of:
for a zip code within which the current home is located, using available data on other homes within the zip code to determine the prescribed price and the prescribed duration of time.

17. The loan origination system of claim 16 wherein using available data on other homes within the zip code to determine the prescribed price and the prescribed duration of time includes determining risk of selling homes located within the zip code as a function of sales price and days on the market.

18. The loan origination system of claim 16 wherein using available data on other homes within the zip code to determine the prescribed price and the prescribed duration of time includes assessing a purchase price of the first home as a function of equity in the first home and a mortgage balance of the first home.

19. The loan origination system of claim 15 wherein execution of the at least one set of instructions by the at least one processor causes the at least one processor to further perform the processor-implemented algorithmic operation of:
in conjunction with the offer on the next home by the homeowner being accepted, causing funding of a down payment on the second home to be made using proceeds from the first loan prior to the first home being sold.

20. The loan origination system of claim 15 wherein repaying the first loan and the mortgage balance amount is performed after said funding and closing of the second loan.

21. The loan origination system of claim 20 wherein execution of the at least one set of instructions by the at least one processor causes the at least one processor to further perform the processor-implemented algorithmic operation of:
in conjunction with the offer on the next home by the homeowner being accepted, causing funding of a down payment on the second home to be made using proceeds from the first loan prior to the first home being sold.

22. The loan origination system of claim 21 wherein said origination of the first loan and approval of the second loan are performed prior to the first home being sold.

23. A method for enabling equity in a current home of a homeowner to be used in securing a loan for use in purchasing a next home of the homeowner, the method comprising at least the processor-implemented algorithmic operations of:
as a function of equity in a current home of a homeowner, by at least one processor executing at least one set of instructions accessed thereby from at least one non-transitory computer-readable medium of a loan origination system, deriving terms for a loan offering required for the homeowner to purchase the next home, wherein the loan offering includes origination of a first loan and approval of a second loan and wherein said deriving is performed in accordance with a requirement of a lender of the first loan to buy the current home from the homeowner at a prescribed price in response to expiration of a prescribed duration of time following at least one of acceptance of said offering and an offer by the homeowner of the next home being accepted;
preapproving, by the at least one processor executing the at least one set of instructions accessed thereby from the at least one non-transitory computer-readable medium of the loan origination system, a second loan for purchasing a next home of the homeowner in response to origination of first loan;
initiating, by the at least one processor executing the at least one set of instructions accessed thereby from the at least one non-transitory computer-readable medium of the loan origination system, origination the second loan in response to notification that an offer on the next home has been accepted;
causing, by the at least one processor executing the at least one set of instructions accessed thereby from the at least one non-transitory computer-readable medium of the loan origination system, proceeds provided from the first loan to be used for funding and closing sale of the next home; and
causing, by the at least one processor executing the at least one set of instructions accessed thereby from the at least one non-transitory computer-readable medium of the loan origination system, the first loan and a mortgage balance amount of the first home to be paid off using proceeds from sale of the current home in response to receiving information confirming the current home as being sold.

24. The method of claim 23, further comprising the processor-implemented algorithmic operation of:
for a zip code within which the current home is located, using available data on other homes within the zip code to determine the prescribed price and the prescribed duration of time, wherein said using is performed by the computer-readable non-transitory medium of the loan origination system.

25. The method of claim 24 wherein using available data on other homes within the zip code to determine the prescribed price and the prescribed duration of time includes determining risk of selling homes located within the zip code as a function of sales price and days on the market.

26. The method of claim 24 wherein using available data on other homes within the zip code to determine the prescribed price and the prescribed duration of time includes assessing a purchase price of the first home as a function of equity in the first home and a mortgage balance of the first home.

27. The method of claim 23, further comprising the processor-implemented algorithmic operation of:
in conjunction with the offer on the next home by the homeowner being accepted, causing funding of a down payment on the second home to be made using proceeds from the first loan prior to the first home being sold, wherein said enabling is performed by the non-transitory medium computer-readable of the loan origination system.

28. The method of claim 23 wherein repaying the first loan and the mortgage balance amount is performed after said funding and closing of the second loan.

29. The method of claim 28, further comprising the processor-implemented algorithmic operation of:
in conjunction with the offer on the next home by the homeowner being accepted, causing funding of a down payment on the second home to be made using proceeds from the first loan prior to the first home being sold, wherein said enabling is performed by the non-transitory medium computer-readable of the loan origination system.

30. The method of claim 29 wherein said originating the first loan and approving the second loan are performed prior to the first home being sold.
